(19) United States
(12) Patent Application Publication
(10) Pub. No.: US 2011/0223899 A1
(43) Pub. Date: Sep. 15, 2011

(54) MOBILE PHONE TERMINAL WITH REMOTE CONTROL FUNCTION

(75) Inventor: Yoshifumi Hiraide, Tokyo (JP)

(73) Assignee: Shinten Sangyo Co., Ltd., Tokyo (JP)

(21) Appl. No.: 12/853,288

(22) Filed: Aug. 9, 2010

(30) Foreign Application Priority Data
Mar. 15, 2010 (JP) 2010-85522

(51) Int. Cl. H04M 3/00

(52) U.S. Cl. 455/420

(57) ABSTRACT

A mobile phone terminal with remote control function including a touch panel display and configured to selectively display function display patterns having a plurality of operating icons representing multiple functions including a phone function on the touch panel display, in which the mobile phone terminal has a display unit that displays a remote-control function display pattern for operating one or more external devices by remote control and a switching unit that selectively switches the remote-control function display pattern.

### CROSS-REFERENCE TO RELATED APPLICATIONS

The present patent application claims priority from Japanese Patent Application No. 2010-85522, filed on Mar. 15, 2010, which is hereby incorporated herein by reference in its entirety.

### BACKGROUND OF THE INVENTION

1. Field of the Invention

The present invention relates to a mobile phone terminal equipped with a remote control function, and more particularly, to a mobile phone terminal equipped with a remote control function capable of remotely controlling a variety of external devices, such as a television, air conditioner, audio device, personal computer, or the like.

2. Description of the Related Art

Handheld electronic devices that have multi-touch input screens on the face of the device and which are used as mobile phones have been proposed, for example, in Japanese Patent Application Publication No. 2008-537615 (JP-2008-537615-A).

At the same time, in ordinary homes and the like, remote control devices (hereinafter also simply “remote controls”) are provided separately for televisions, audio devices, personal computers, or air conditioners, lighting fixtures, and other such external devices, and are used as necessary.

However, under these circumstances the number and types remote controls tends to proliferate. Moreover, each device operates differently, which complicates operation and causes problems in terms of operability.

Accordingly, it has been proposed to make it possible to use mobile terminals such as mobile phones as the above-described remote control devices as well. However, the required operating buttons and so forth differ with each device, and it sometimes happens that an operation that is completely different from the one intended is carried out instead, making compatibility difficult and complicated to achieve and leading to cost increases.

### SUMMARY OF THE INVENTION

The present invention is conceived in view of the above-described circumstances, and provides a novel mobile phone terminal with remote control function capable of switching between and displaying different operating screens with a simple switching operation, which can be selectively used for remote control of a variety of different types of devices, and which provides superior operability.

In at least one embodiment, there is provided a mobile phone terminal with remote control function including a touch panel display and configured to selectively display function display patterns having a plurality of operating icons representing multiple functions including a phone function on the touch panel display. The mobile phone terminal has a display unit that displays a remote-control function display pattern for operating one or more external devices by remote control and a switching unit that selectively switches the remote-control function display pattern.

The switching unit may be a main operation display pattern for selecting and switching a multi-function display pattern included among the function display patterns.

The function display pattern may be used for any of a phone, PDA, audio player, camera, video player, game player, internet terminal, and GPS receiver. The external device may be any of a television, an air conditioner, audio equipment, a video player, a personal computer, a PDA, and a light.

The mobile phone terminal with remote control function as described above displays remote control operation display patterns for remote control operation of a variety of different devices on a display of the terminal, such that, by operating certain operating icons of these display patterns, different device can be operated by remote control. Accordingly, the mobile phone terminal of the present invention, in addition to functioning as an ordinary phone, can operate a variety of different devices as circumstances require by remote control.

Additional features and advantages of the present invention will be more fully apparent from the following detailed description, the accompanying drawings, and the associated claims.

### BRIEF DESCRIPTION OF THE DRAWINGS

FIGS. 1A and 1B are schematic diagrams illustrating an external appearance of a mobile phone terminal with remote control function according to one embodiment of the present invention;

FIG. 2 is a schematic diagram showing a configuration of a mobile phone terminal with remote control function according to one embodiment of the present invention; and

FIG. 3 is a flowchart showing a mobile phone terminal with remote control function according to one embodiment of the present invention and illustrating operation thereof.

### DETAILED DESCRIPTION OF PREFERRED EMBODIMENTS

Preferred embodiments of the present invention will now be described in detail, with reference to the accompanying drawings.

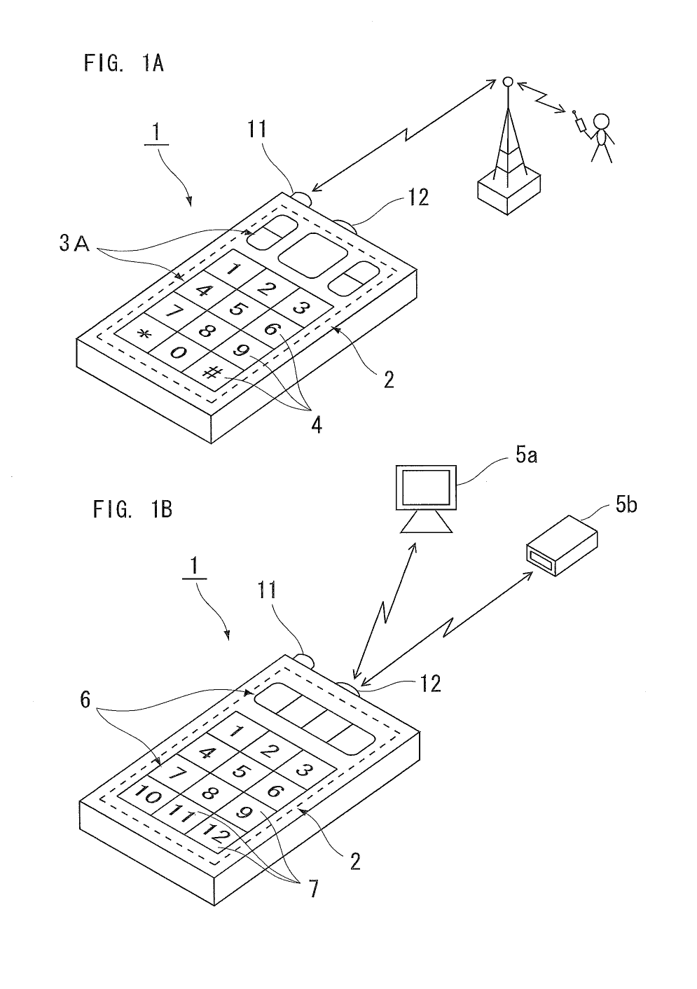

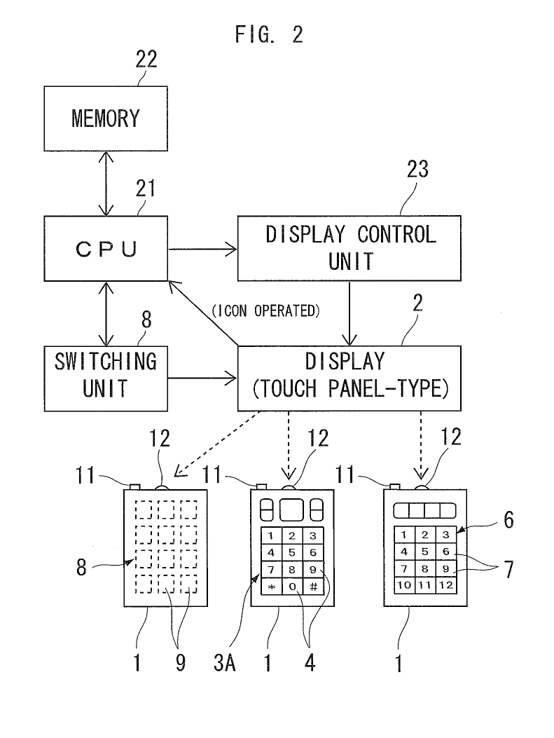

FIG. 1 and FIG. 2 show a mobile phone terminal with remote control function according to one embodiment of the present invention.

In FIGS. 1 and 2, reference numeral 1 designates a mobile phone terminal that is equipped with a touch panel display 2. The mobile phone terminal 2 is configured so as to display on the display 2 a display pattern for a phone function 3A as shown in FIG. 1A, for making the mobile phone function as a phone.

Further, the mobile phone terminal 1 has additional function display patterns 3B, 3C, . . . 3n that serve as displays for operating, in addition to the phone function, such other functions as a PDA, audio player, camera, video player, game player, internet terminal, personal computer, GPS receiver, and so forth.

The respective display patterns 3B, 3C . . . 3n are installed as convenient and each one includes one or more operating icons 4, such that, by appropriate operation of the operating icons, the mobile phone terminal 1 can made to operate accordingly.

Of course, the above-described mobile phone terminal 1 is provided with the necessary hardware in the form of controller, receiver, transmitter, speaker, microphone, memory, and the like, for implementation of the functions represented by, and operated on the basis of the operation of, the operating icons 4 of the above-described display patterns 3A, 3B, 3C, . . . 3n.

In addition to the function displays for phone function and the like 3A, 3B, 3C, . . . 3n described above, the mobile phone terminal 1 according to the present embodiment also displays a remote control operating display pattern 6 as shown in FIG. 1B for remote control operation of a variety of different external devices 5a, 5b, . . . 5n, including but not limited to televisions, audio equipment, personal computers, and the like. Like the function display patterns 3A, 3B, 3C, . . . 3n, the remote control operating display pattern 6 also includes one or more operating icons 7. Operation of these operating icons 7 transmits a signal, which may be an infrared ray, to the external devices 5a, 5b, . . . 5n to operate the external devices by remote control using the mobile phone terminal 1 as a remote control device.

It is to be noted that, as shown in FIGS. 1A and 1B, the mobile phone terminal 1 of the present embodiment has an antenna 11 for the phone function provided at a top edge portion of the main body of the mobile phone terminal 1, and is further provided with an infrared ray emitter 12 that emits infrared light beams for remote control operation of a targeted device.

Further, according to the present embodiment, a main operating display pattern 8 (shown in FIG. 2) is provided as one of the above-described function display patterns 3A, 3B, 3C, . . . 3n. The main operating display pattern 8 functions as switching means to enable a user to selectively switch the remote control operating display pattern 6. Like the function display patterns 3A, 3B, 3C, . . . 3n and the remote control operating display pattern 6, the main operating display pattern 8 also includes one or more operating icons 9. Operating a given operating icon 9 displayed on the main operating display pattern 8 causes that function display pattern 3A, 3B, 3C, . . . 3n which corresponds to the selected operating icon 9 from among all the function display patterns 3A, 3B, 3C, . . . 3n to be displayed.

Thus, with the above-described configuration, by selectively displaying the remote control operating display pattern 6 on the display 1 that becomes a touch panel input screen, the mobile phone terminal 1 can be utilized as a remote control device for a variety of different external devices 5a, 5b, . . . 5n.

FIG. 2 is a schematic diagram showing a configuration of the mobile phone terminal 1 with remote control function according to the present invention. In FIG. 2, reference numeral 21 designates a central processing unit (CPU) for controlling operation of the various functions of the mobile phone terminal 1. Reference numeral 22 designates a memory that serves as storage means for storing application software and the like installed in the mobile phone terminal 1 for implementing the respective functions on the basis of operation of individual icons displayed in the function display patterns 3A, 3B, 3C, . . . 3n, the remote control operating display pattern 6, and the main operating display pattern 8. Reference numeral 23 designates a display control unit for displaying the function display patterns 3A, 3B, 3C, . . . 3n, the remote control operating display pattern 6, and the main operating display pattern 8 on the display 2.

The display 2 is configured as a touch panel. By operating as appropriate the respective operating icons 4, 7, and 9 shown in the function display patterns 3A, 3B, 3C, . . . 3n, the remote control operating display pattern 6, and the main operating display pattern 8 displayed on the display 2, the appropriate action is carried out by the CPU 21.

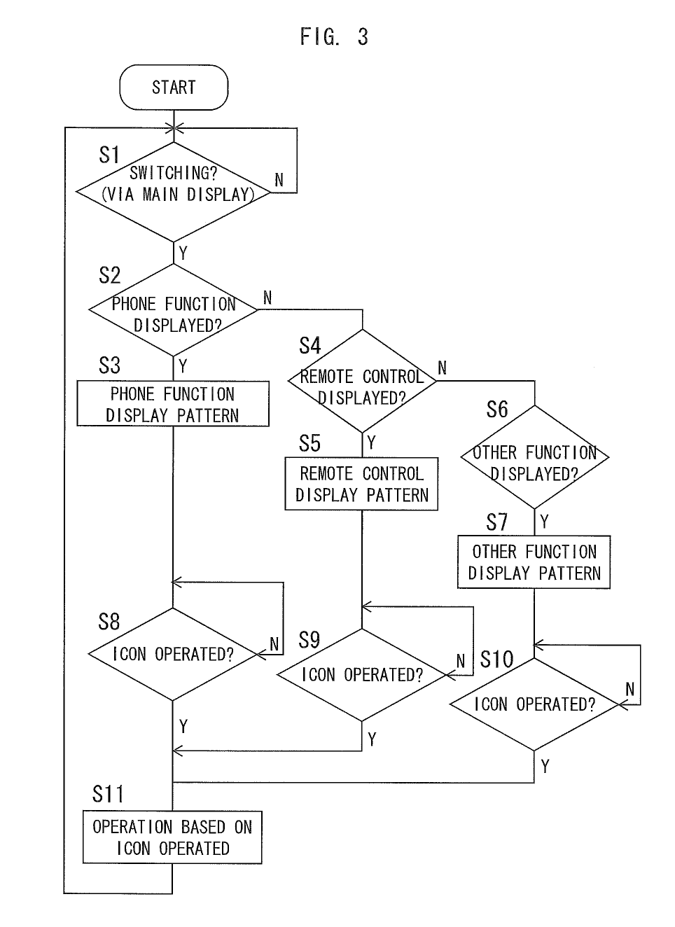

FIG. 3 is a flowchart showing operation of the above-described mobile phone terminal 1 with remote control function.

In step S1, when a given operating icon 9 in the main operating display pattern 8, which is the switching means described above, is operated, processing then proceeds to step S2. At step S2, it is determined whether or not the display selected is the phone function display, and if so, processing then proceeds to step S3 where the phone function display 3A is displayed on the display 2.

On the other hand, if in step S2 it is determined that the selected display is not the phone function display, processing then proceeds to step S4 where it is determined whether or not the display is the remote control function display. If so, processing then proceeds to step S5 and the remote control operating display pattern 6 is displayed.

If in step S4 it is determined that the display is not the remote control function display, processing then proceeds to step S6, where it is determined whether or not there is some other function display involved. If so, processing then proceeds to step S7, where display of the appropriate display pattern 3B, 3C, . . . 3n is carried out.

When in steps S8, S9, and S10 it is detected that an icon in any of the display patterns has been operated, in step S11 an operation based on that icon is carried out, and respective function operations are carried out as appropriate.

It is to be noted that the mobile phone terminal 1 according to the above-described embodiment of the present invention is not limited to the configuration described above, and accordingly, the shapes, structure, dimension and so forth of the various constituent components thereof may be modified as appropriate.

For example, although in the above-described embodiment the mobile phone terminal 1 uses an infrared ray emitter 12 for remote control, the present invention is not limited thereto but encompasses anything that is capable of operating an external device remotely without contacting the device. Therefore, for example, other than infrared rays it is possible to employ ultrasound, radio waves, light, sound, or any short-range communications technology or technique, and the hardware adapted thereto.

In addition, although the mobile phone terminal 1 according to the embodiment described above is described as displaying different displays for different functions such as a phone, an audio player, a camera, a video player, and so forth, the present invention is not limited thereto and may be configured to carry out any appropriate function.

Further, although in the above-described embodiment televisions, audio equipment, and the like are given as examples of the various types of external devices to be operated by remote control, the present invention is not limited thereto but includes any household or other electrical appliance capable of being operated by remote control, including, but not limited to, televisions, air conditioners, audio equipment, personal computers, lights and lighting equipment, and so on.

Although the present invention has been described with reference to specific embodiments, it is to be understood that the invention is not limited to such disclosed embodiments but encompasses all modifications, improvements, and equivalent structures and functions. It is therefore to be understood that, within the scope of the associated claims, the present invention may be practiced otherwise than as described herein.

What is claimed is:

1. A mobile phone terminal with remote control function including a touch panel display and configured to selectively display function display patterns having a plurality of operating icons representing multiple functions including a phone function on the touch panel display,
the mobile phone terminal comprising:
a display unit that displays a remote-control function display pattern for operating one or more external devices by remote control; and
a switching unit that selectively switches the remote-control function display pattern.

2. The mobile phone terminal with remote control function according to claim 1, wherein the switching unit comprises a main operation display pattern for selecting and switching a multi-function display pattern included among the function display patterns.

3. The mobile phone terminal with remote control function according to claim 1, wherein the function display pattern is for at least one of a phone, PDA, audio player, camera, video player, game player, internet terminal, and GPS receiver.

4. The mobile phone terminal with remote control function according to claim 1, wherein the external device is one of a television, an air conditioner, audio equipment, a video player, a personal computer, a PDA, and a light.
